(19) United States
(12) Patent Application Publication
(10) Pub. No.: US 2005/0276222 A1
(43) Pub. Date: Dec. 15, 2005

(54) Platform level overload control

(76) Inventors: Gopal N. Kumar, Morristown, NJ (US); Stacy Gail Fishkin, Mahwah, NJ (US)

Correspondence Address: CARLSON, GASKEY & OLDS, P.C., 400 WEST MAPLE ROAD, SUITE 350, BIRMINGHAM, MI, 48009, US

(21) Appl. No.: 10/865,106

(22) Filed: Jun. 10, 2004

(51) Int. Cl. G01R 31/08

(52) U.S. Cl. 370/235; 370/395.42

(57) ABSTRACT

A communication system includes overload control at a platform level. A translator module receives messages from any number of distinct networks and provides priority information regarding each of those messages to an overload control module that uses the translated priority information and arrival rate information to provide needed message traffic control. The disclosed arrangement provides a universally applicable overload control approach that reduces duplicated resources associated with individual overload control algorithms for each network message processor.

### FIELD OF THE INVENTION

This invention generally relates to telecommunications, and more particularly to wireless communication systems.

### DESCRIPTION OF THE RELATED ART

Wireless communication systems have grown increasingly in popularity and in capabilities. Current systems provide voice communication, data communication and other multi-media applications. As technology progresses, the capabilities in these areas continue to improve.

Managing the flow of information in such systems is of critical importance. For example, a variety of messages must be processed by a system controller for optimal communications to be maintained. Typical controllers or processors have a maximum capacity. Under most circumstances, the capacity is not reached and the processor occupancy (PO) is at a level that allows for effective maintenance of the desired communications among subscribers within a network, for example. There are times, however, when the PO exceeds the controller capacity and measures must be taken to handle such overload situations.

Data flow in a wireless network is typically bursty; there may be periods with low volumes and others with high volumes. It follows that even with a manageable average traffic volume, a processor may experience instantaneous processing loads that exceed the average value and may exceed the processor capacity. Such situations must be dealt with effectively to avoid end-to-end delays and other quality-of-service deteriorations. Handling an overload situation and minimizing the amount of time it would take to recuperate from such a situation is important. Ideally, processors are protected from overload situations using overload control algorithms.

Known overload control algorithms react to an overload situation by reducing a processor's exposure to message processing loads. Typical messages included are signaling messages, data-payload or operations messages and maintenance messages. A typical algorithm will drop or delay some of these messages using some form of negotiation with the source or buffer for some of the messages to effectively reduce the number of messages to be handled by the processor in a given interval. Some algorithms combine dropping and delaying techniques. The effectiveness of an algorithm depends upon how it reacts to different messages. Some algorithms do not discriminate among messages while others recognize relative message priorities and use such information when deciding what message(s) to drop or delay.

System performance metrics determine how important a given message is. Some overload control algorithms include attributing importance to different message types. Relative priorities of messages sometimes dictate how messages are to be dropped during overload situations. For example, if there are multiple classes of subscribers based upon their subscription rates, those paying more for services will have higher priority than those paying less. Some message types are higher priority based on content and functionality.

Simply dropping the lowest priority messages may not solve an overload problem where a large number of high priority messages are arriving within a certain time interval. An overload algorithm typically requires an ability to determine how many messages of each priority should be dropped to address an overload situation.

One shortcoming of typical overload control algorithms is that they require opening each message to determine its priority and whether a particular message will be processed or dropped. Opening each message is computationally expensive. An overload control algorithm that imposes too high of a computational cost to determine priority information typically is not used because of the additional computational cost. This is a significant reason why priority-sensitive overload control is not implemented as often as would be beneficial.

Another layer of complexity is presented by the fact that each different network (i.e., UMTS, EV-DO, CDMA, TDMA, etc.) has its own signaling and traffic messages. An overload control algorithm typically is dedicated to a particular technology such that the overload control is made aware of such details. Developing separate control algorithms for each network or technology adds complexity to the systems and increases cost because of the duplication of efforts in overload control development and implementation.

There is a need for an improved approach to overload control that reduces the costs associated with providing adequate control for each of a variety of networks. This invention addresses that need by providing an overload control approach that can operate at a platform level and provide overload control to a plurality of networks even when they are differing technologies.

### SUMMARY OF THE INVENTION

In general terms, this invention is an overload control approach that uses translated priority information regarding messages at a platform level so that a generic overload control algorithm may be used for a variety of distinct networks having network elements at a network level.

One example method of handling message overload in a communication system having a platform level and a plurality of networks at a network level includes translating messages from at least one of the networks into priority information for each of the messages at the platform level and throttling messages selected on the basis of their relative translated priorities.

The method of one example includes translating messages from each of the plurality of networks at the platform level. The same example includes providing a translator module that provides the priority information for the messages of each of the networks and tracking correspondence between each of the networks and the messages.

One example includes using a single overload control algorithm for the messages from each of the networks and using the translated priority information and an arrival rate of the messages for selecting messages for throttling.

In one example method, the overload control includes dropping selected messages at the platform level and providing remaining messages to a corresponding message processor at the network level. Another example overload control algorithm utilizes the technique of delaying selected messages at the platform level and providing remaining messages to a corresponding message processor at the network level before providing the delayed messages.

The various features and advantages of this invention will become apparent to those skilled in the art from the following detailed description. The drawings that accompany the detailed description can be briefly described as follows.

### BRIEF DESCRIPTION OF THE DRAWING

FIG. 1 schematically illustrates selected portions of a communication system incorporating overload control designed according to one example embodiment of this invention.

### DETAILED DESCRIPTION

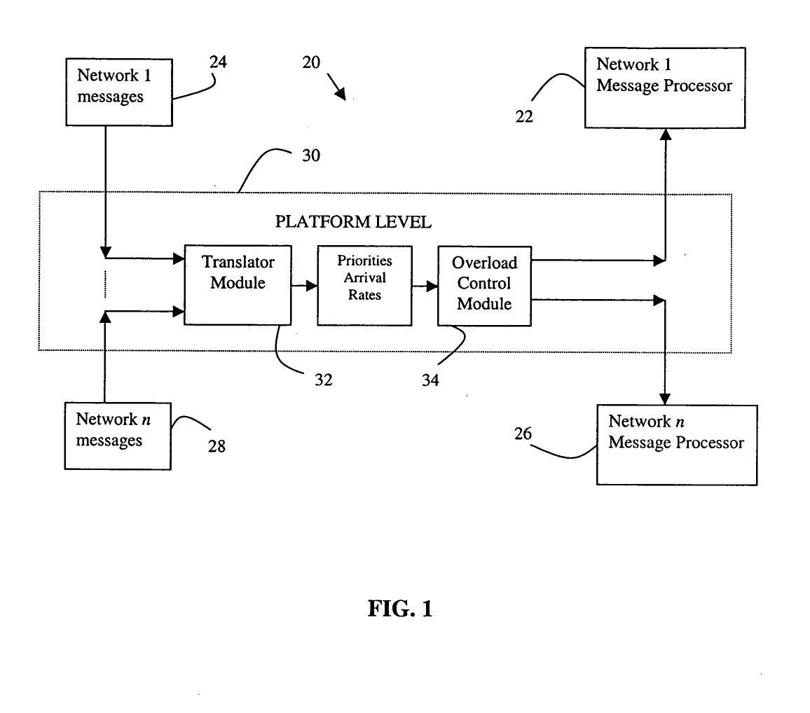

FIG. 1 schematically shows portions of a communication system 20 that is useful for facilitating wireless communications among mobile customers, for example. The example system includes a plurality of networks at a network level. A first example network includes a message processor 22 that processes a plurality of messages 24 in a known manner. Another network message processor 26 is associated with another network for processing plurality of messages 28 in a known manner. Although two network message processors are shown, the example system 20 may include more networks or just one. In one example system, the different networks utilize different technologies such as UMTS, EV-DO, CDMA, TDMA, for example.

Each network processor has a maximum processor occupancy (PO) based on the memory and processing speed of the particular network elements selected. In most situations, the processors are capable of handling message traffic. There are times, however, when the volume of messages exceeds the PO and overload control is necessary. In typical systems, each processor has its own overload control algorithm and processing. With the example system configuration, an overload control is provided at a platform level 30.

As schematically shown, the messages 24 and 28 are processed at the platform level 30 to provide overload control for each of the message processors. A translator module 32 receives the messages from as many networks as are included in the system 20. The translator module determines what types of messages are received and translates each into a priority value or priority indicator. As different networks have different messages and different priority schemes, the example translator module 32 has the capability to recognize each message type for each associated network and is designed to recognize relative priorities between the message types.

For example, one network includes set-up messages, paging messages and power control messages. These have different priorities with the power control messages having the highest priority and the paging messages having the lowest priority. The translator module uses known techniques to discern the type of each received message. The translator module associates a priority value such as 1, 2 or 3 in this example with each message and provides the priority information to an overload control module 34. By translating the message types of the different networks into a common or generic priority scheme, the translator module allows a single overload control algorithm, which operates based on the translated priority values, to provide overload control to each of a variety of networks.

The translator module in this example also determines an arrival rate of messages using known techniques. The translated priority and arrival rate information are provided to the overload control module 34 in this example.

The overload control module 34 uses a selected overload control technique to reduce the volume of messages provided to the corresponding message processor 22 or 26, for example. The overload control module 34 in this example, uses the same approach for each of the networks even though the types of messages, message content and relative priorities may vary significantly between the networks. Using the translated priority information enables a single overload control algorithm to provide overload control to a variety of networks, thereby reducing duplication of resources among the various networks.

The translator module 32 and the overload control module 34 keep track of which messages are for a particular system and route them accordingly.

The example overload control module exploits the fact that most overload control algorithms seek to reduce PO by throttling at least some messages (i.e., dropping some messages or delaying processing of some messages until the processor is less occupied) based upon priority information. The translator module 32 provides a layer of transparency to the overload control module 34 so that the overload control module provides at least somewhat universal or generic overload control. By providing relative message importance (i.e., priority) information to the overload control algorithm, each network's messages can be selectively throttled to meet the PO of each network processor.

In one example, the translator module 32 has a plurality of data files that relate the various message types to their relative priorities for each network, respectively. The data files enable the translator module to recognize a message type and translate that into one of the priority values that is recognized by the overload control module 34. Those skilled in the art who have the benefit of this description will be able to develop the programming necessary to be able to translate message priorities into the generic priority values that will work with their particular overload control algorithm.

In one example, the overload control module 34 uses arrival rate information of the messages types corresponding to each of the priority values to assign appropriate overload control parameter values (i.e., acceptance fractions, rejection fractions or critical values). Some part of the platform level overload control arrangement such as the translator module has information regarding the various network message processor PO levels to provide appropriate overload control.

The translator module and the overload control module may comprise software, hardware, firmware or a combination of these. Those skilled in the art who have the benefit of this description will be able to select appropriate combinations to meet the needs of their particular situation.

In one example, all network messages are processed through the overload control arrangement at the platform level and PO information combined with the respective arrival rates indicates when messages should be throttled for a particular system. In one example, the overload control module includes programming that enables it to recognize when a particular processor will be overloaded so that the throttling algorithm provides the necessary reduction in PO. In another example, the message processors of the individual networks normally receive messages directly and the processors provide an indication to the overload control arrangement at the platform level when overload control is required. Under such circumstances, the messages are routed through the platform level to provide overload control.

There are a variety of known techniques that can be used in the overload control module 34 to achieve the necessary throttling to stay within a particular message processor's PO. Given this description, those skilled in the art will be able to select an appropriate overload algorithm to provide a platform-level, generically applicable overload control to meet their particular needs.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A method of handling message overload, comprising the steps of:
translating messages from at least one network at a network level into priority information for each of the messages at a platform level; and
throttling at least selected ones of the messages at the platform level based on the translated priority information.

2. The method of claim 1, comprising translating messages from each of a plurality of networks at the platform level.

3. The method of claim 2, comprising providing a translator module that provides the priority information for the messages of each of the networks and tracking correspondence between each of the networks and the messages.

4. The method of claim 3, comprising using a single overload control algorithm for the messages from each of the networks.

5. The method of claim 4, comprising using the translated priority information and an arrival rate of the messages for selecting messages for throttling.

6. The method of claim 1, wherein the throttling comprises:
dropping the selected messages at the platform level; and
providing remaining messages to a corresponding message processor at the network level.

7. The method of claim 1, wherein the throttling comprises:
delaying the selected messages at the platform level; and
providing remaining messages to a corresponding message processor at the network level before providing the delayed messages.

8. The method of claim 1, comprising using the translated priority information and an arrival rate of the messages for selecting messages for throttling.

9. A communication system, comprising:
at least one network at a network level, the network including a message processor;
a translator module at a platform level for receiving messages from the network level and for translating the messages into priority information; and
an overload control module at the platform level that throttles selected ones of the translated messages based on the translated priority information before providing the messages to the network message processor.

10. The system of claim 9, comprising a plurality of distinct networks at the network level and wherein the translator module and the overload control module handle messages from each of the plurality of networks.

11. The system of claim 10, wherein the overload control module uses a single overload control algorithm for handling messages from each of the networks.

12. The system of claim 11, wherein the overload control module uses the translated priority information and arrival rate information for selecting the messages to be throttled.

13. The system of claim 9, wherein the overload control module drops the selected messages at the platform level and provides remaining messages to the message processor at the network level.

14. The system of claim 9, wherein the overload control module delays the selected messages at the platform level and provides remaining messages to the message processor at the network level before providing the delayed messages to the message processor.

15. The system of claim 9, wherein the overload control module drops at least one of the selected messages at the platform level, delays at least one of the selected messages at the platform level and provides remaining messages to the processor at the network level.
